(19) United States
(12) Patent Application Publication
(10) Pub. No.: US 2022/0368421 A1
(43) Pub. Date: Nov. 17, 2022

(54) CONCENTRIC-CORE FIBERS AND SYSTEM USING SAME

(71) Applicant: COMMSCOPE TECHNOLOGIES LLC, Hickory, NC (US)

(72) Inventors: John Charles CHAMBERLAIN, Hickory, NC (US); Michael Aaron KADAR-KALLEN, Harrisburg, PA (US); Earl R. PARSONS, Allen, TX (US)

(73) Assignee: COMMSCOPE TECHNOLOGIES LLC, Hickory, NC (US)

(21) Appl. No.: 17/621,347

(22) PCT Filed: Jun. 19, 2020
(86) PCT No.: PCT/US2020/038744

§ 371 Date: Dec. 21, 2021

Related U.S. Application Data
(60) Provisional application No. 62/864,804, filed on Jun. 21, 2019.

(51) Int. Cl. H04B 10/25; G02B 6/42; G02B 6/036; G02B 6/028; G02B 6/02

(52) U.S. Cl. CPC H04B 10/25; G02B 6/4246; G02B 6/03644; G02B 6/0281; G02B 6/02042

(57) ABSTRACT

Optical systems that employ concentric multi core fibers (MCFs) are discussed. Some of the systems discussed are based on the use of a concentric MCF that has a single mode core, capable of carrying a broadband data signal, and a multimode core, which carries optical signals that do not require as high a bandwidth as the broadband data signal. In one embodiment, the multimode core carries system management data. In another embodiment, the multimode core carries a high power optical signal that provides remote power. In another embodiment, the multimode core carries a pump signal for a downstream fiber amplifier. In yet another embodiment, the multimode core carries an optical signal, for example visible light, that can be used to verify connectivity.

### CROSS-REFERENCE TO RELATED APPLICATION

This application is being filed on Jun. 19, 2020 as a PCT International Patent Application and claims the benefit of U.S. Patent Application Ser. No. 62/864,804, filed on Jun. 21, 2019, the disclosure of which is incorporated herein by reference in its entirety.

### BACKGROUND OF THE INVENTION

The present invention is generally directed to optical communications, and more specifically to improved methods for increasing the capacity for signals carried by a single optical fiber.

There have been recent proposals for increasing the information carrying capacity in fibers using space division multiplexing (SDM) based on fibers having multiple concentric cores, i.e. a central core surrounded by cylindrical cores. Such fibers may be referred to as concentric multi-core fibers (MCFs). When concentric MCFs are employed simply for carrying data traffic, each concentric core is typically capable of supporting a single radial mode or a few modes.

In addition to simply increasing communications bandwidth, concentric MCFs can find use in other applications. The present invention addresses some of these applications of concentric MCFs.

### SUMMARY OF THE INVENTION

One embodiment of the invention is directed to an optical system that has a transmitter portion, the transmitter portion comprising at least a first transmitter unit to generate an optical data signal and a second transmitter unit to generate an optical system management signal. The optical system also includes a receiver portion; and a fiber portion coupling between the transmitter portion and the receiver portion. The fiber portion comprises at least one concentric multicore fiber (MCF) that carries the optical data signal from the first transmitter unit in a first core and carries the optical system management signal from the second transmitter unit in a second core. In some embodiments, the optical data signal is carried in a single mode core of the concentric MCF and the optical system management signal is carried in a multimode core of the concentric MCF.

Another embodiment of the invention is directed to an optical system that includes a transmitter portion that has at least a first transmitter unit to generate an optical data signal and a second transmitter unit to generate an optical power signal. The optical system also includes a receiver portion and a fiber portion coupling between the transmitter portion and the receiver portion. The fiber portion has at least one concentric multicore fiber (MCF) that carries the optical data signal from the first transmitter unit in a first core and carries the optical power signal in a second core. The optical power signal is converted to an electrical power signal at the receiver portion. The electrical power signal is used to provide electrical power to one or more components of the receiver portion. In some embodiments, the optical data signal is carried in a single mode core of the concentric MCF and the optical power signal is carried in a multimode core of the concentric MCF.

Another embodiment of the invention is directed to an optical system that includes a transmitter portion that has at least a first transmitter unit to generate an optical data signal and a second transmitter unit to generate an optical pump signal. The optical system also includes a receiver portion and a fiber portion coupling between the transmitter portion and the receiver portion. The fiber portion has at least one concentric multicore fiber (MCF) that carries the optical data signal from the first transmitter unit in a first core and carries the optical pump signal in a second core, the fiber coupling portion further comprises a fiber amplifier coupled to receive both the optical data signal and the optical pump signal from the concentric MCF. The fiber amplifier includes an amplifying medium, and the optical pump signal has a wavelength selected to be absorbed by the amplifying medium of the fiber amplifier. In some embodiments, the optical data signal is carried in a single mode core of the concentric MCF and the optical pump signal is carried in a multimode core of the concentric MCF.

Another embodiment of the invention is directed to an optical system that includes a transmitter portion that has at least a first transmitter unit to generate an optical data signal and a second transmitter unit to generate an optical power signal. The optical system also includes a receiver portion and a fiber portion coupling between the transmitter portion and the receiver portion. The fiber portion has at least one concentric multicore fiber (MCF) that carries the optical data signal from the first transmitter unit in a first core and carries the optical power signal in a second core. The fiber portion further comprises a fiber amplifier coupled to receive the optical data signal from the at least one concentric MCF. The optical power signal is converted to an electrical power signal at an amplifier pump unit of the fiber amplifier. The electrical power signal is used to provide electrical power the amplifier pump unit, whereby the amplifier pump unit provides optical pump power to the fiber amplifier. In some embodiments, the optical data signal is carried in a single mode core of the concentric MCF and the optical power signal is carried in a multimode core of the concentric MCF.

Another embodiment of the invention is directed to an optical system that includes a transmitter portion that has at least a first transmitter unit to generate an optical data signal and a second transmitter unit to generate an optical connectivity-indicating signal. The optical connectivity-indicating signal has a wavelength in the range of approximately 400 nm-700 nm. The optical system also includes a receiver portion and a fiber portion coupling between the transmitter portion and the receiver portion. The fiber portion has at least one concentric multicore fiber (MCF) that carries the optical data signal from the first transmitter unit in a first core and carries the optical connectivity-indicating signal in a second core. In some embodiments, the optical data signal is carried in a single mode core of the concentric MCF and the connectivity-indicating signal is carried in a multimode core of the concentric MCF.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1A and 1B schematically illustrate an exemplary circularly symmetric, radial refractive index profile of a concentric multicore fiber (MCF), having a single mode central core and a multimode cylindrical core, as may be used in an embodiment of the present invention;

FIGS. 2A and 2B schematically illustrate another exemplary circularly symmetric, radial refractive index profile of a concentric MCF, having a single mode central core and a multimode cylindrical core, as may be used in an embodiment of the present invention;

FIGS. 3A and 3B schematically illustrate another exemplary circularly symmetric, radial refractive index profile of a concentric MCF, having a single mode central core and a multimode cylindrical core, as may be used in an embodiment of the present invention;

FIGS. 4A and 4B schematically illustrate another exemplary circularly symmetric, radial refractive index profile of a concentric MCF, having a single mode central core and a multimode cylindrical core, as may be used in an embodiment of the present invention;

FIG. 5 schematically illustrates an optical communication system that employs a concentric MCF for delivering a broadband data signal and a system management signal, according to an embodiment of the present invention;

FIGS. 6A and 6B schematically illustrate an embodiment of a space division multiplexing (SDM) coupler that may be used in an optical communication system according to the present invention;

FIG. 7 schematically illustrates an optical communication system that employs a concentric MCF for delivering a broadband data signal and an optical power signal for remote conversion to an electrical signal used to power remote equipment, according to an embodiment of the present invention;

FIGS. 8A-8C each present different arrangements for an optical/electrical converter for converting an optical power signal to an electrical signal in an optical communications circuit according to the present invention;

FIG. 9 schematically illustrates an optical communication system that employs a concentric MCF for delivering a broadband data signal and an optical pump signal for remote pumping of a fiber amplifier, according to an embodiment of the present invention;

FIG. 10 schematically illustrates an optical communication system that employs a concentric MCF for delivering a broadband data signal and an optical power signal for providing power to a remote fiber amplifier pump, according to an embodiment of the present invention;

FIG. 11 schematically illustrates an optical communication system that employs a concentric MCF for delivering a broadband data signal and a connectivity-indicating signal, according to an embodiment of the present invention;

FIG. 12 schematically illustrates an embodiment for coupling light into and out of the concentric MCF according to the present invention; and

FIG. 13 schematically illustrates another embodiment for coupling light into and out of the concentric MCF according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

A concentric multicore fiber (MCF) MCF is an optical fiber that contains two or more concentric volumes of material having a higher refractive index than the immediately surrounding material (core), designed to allow different light signals to separately propagate in a confined manner along each respective concentric core. For example, the concentric MCF may contain an axial core of relatively high refractive index, surrounded by one or more cylinders of relatively high refractive material forming cylindrical cores, where the cylindrical cores are separated from each other by volumes of relatively low index material (cladding). The relatively high and low refractive index material may be, for example, doped or undoped regions of silica glass.

Concentric MCFs may contain concentric cores that are capable of propagating only a single radial mode, may contain concentric cores that propagate multiple radial modes, or may contain one or more concentric cores capable of propagating a single radial mode and one or more concentric cores capable of propagating multiple radial modes.

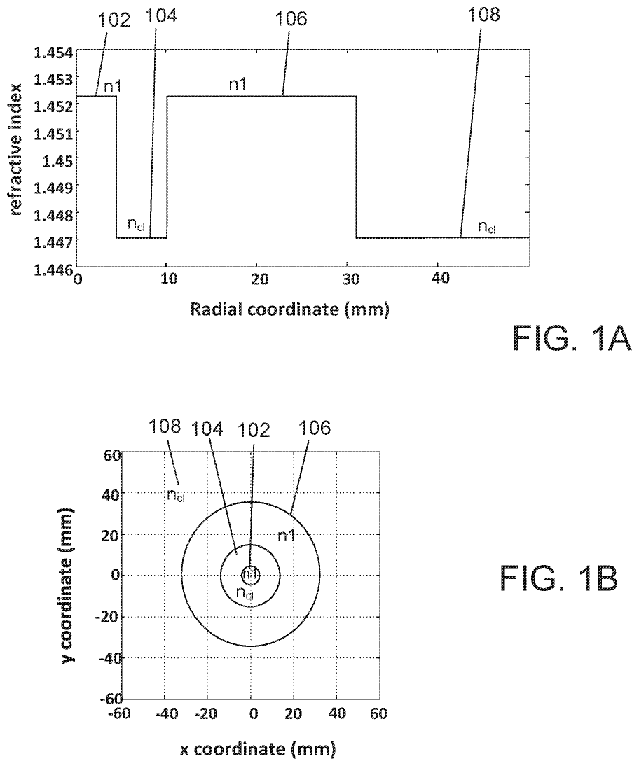

The refractive index profile of one exemplary embodiment of a concentric MCF fiber having two concentric cores is described with reference to FIGS. 1A and 1B. FIG. 1A shows the refractive index profile as a function of radial position from the center of the fiber, while FIG. 1B shows the refractive index contours of a cross-sectional profile of the fiber. In this embodiment, there is a central core 102 of material having a relatively high refractive index, n1. The central core 102 is surrounded by a first cladding ring 104 of material having a relatively low refractive index, n_{c1}. The first cladding ring 104 is surrounded by a first cylindrical core 106 formed of material having a relatively high refractive index, n1. The first cylindrical core 106 is surrounded by a second cladding layer 108, with a refractive index of rid. The central core 102 and the first cylindrical core 106 (and any other rings of relatively high index material surrounding the central core and the first ring 106) are referred to as concentric cores.

A concentric MCF can be made using known processes for providing a desired refractive index profile in an optical fiber, such as a silica optical fiber, including chemical vapor deposition techniques such modified chemical vapor deposition (MCVD) or plasma enhanced chemical vapor deposition (PCVD), or processes described in U.S. Pat. No. 6,062,046.

The values of refractive index for n1 and n_{c1} are properties of the material used for the concentric cores and cladding. In the particular embodiment of concentric MCF shown in FIGS. 1A and 1B, the central core 102 has a refractive index of 1.452 and a radius of around 4 μm, the first cladding layer 104 has an index of 1.447 and is present in the radial region from about 4 μm to about 10 μm. The first cylindrical core 106 has a refractive index the same as the core region 102 and is radially located between about 10 μm and 31.25 μm from the fiber center. The second cladding layer 108 has the same refractive index as the first low cladding layer 104 and is located at a radial distance beyond the first cylindrical core 106, i.e. beyond about 31.25 μm from fiber center. Thus, the refractive index difference between the high and low index regions of this embodiment of fiber is about 0.005. However, other values of refractive index may be used in the different high index regions and low index regions, depending on the material used for the fiber and the level of doping, the core region may extend to a different radius, and the cylindrical concentric core region 106 may extend radially between different values of radius. The outer radius of the second cladding layer 108 is not shown in FIG. 1B. Many conventional fibers have an outer cladding diameter of 125 μm. If the concentric MCF also had an outer cladding diameter of 125 μm, then it may be used with standard types of optical fiber connector, for example, SC, LC, MPO amongst others.

Some conventional multimode fibers, e.g. OM1, FDDI fibers have a multimode core diameter of 62.5 μm, i.e. a radius of 31.25 μm, and so a fiber of this design might, in some applications, be compatible with standard multimode fibers. However, the diameter of the multimode cylindrical core need not be limited to 62.5 μm, as is discussed in the exemplary embodiments below. For example, the diameter of the multimode cylindrical core may be set at 50 μm, which matches other conventional multimode fibers, such as OM2, OM3 and OM4.

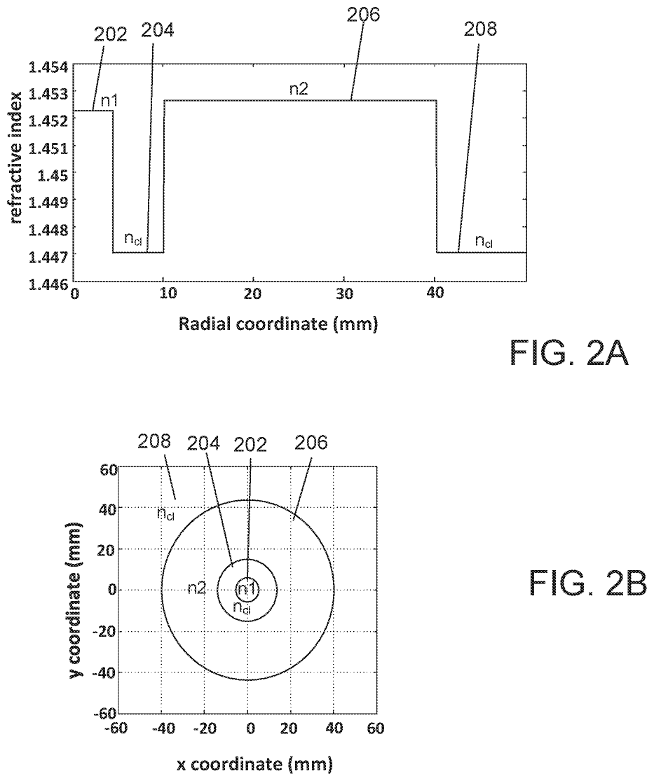

The refractive index profile of another exemplary embodiment of a concentric MCF fiber having two concentric cores is described with reference to FIGS. 2A and 2B. FIG. 2A shows the refractive index profile as a function of radial position from the center of the fiber, while FIG. 2B shows the refractive index contours of a cross-sectional profile of the fiber. In this embodiment, there is a central core 202 of material having a first relatively high refractive index, n1. The central core 202 is surrounded by a first cladding layer 204, having a relatively low refractive index, n_{c1}. The first cladding layer 204 is surrounded by a first cylindrical core 206 having a relatively high refractive index, n2 that is different from the first high refractive index, n1. In the illustrated embodiment, n2 is greater than n1, although this is not a necessary condition, and in other embodiments, n2 may be less than n1. The first cylindrical core 206 is surrounded by material having a second cladding layer 208, with a relatively low refractive index of n_{c1}. In this embodiment, the radius of the central core 202 extends from the center of the fiber to about 4 μm, the radial extent of the first cladding layer 204 is about 4 μm to about 10 μm, the radial extent of the first cylindrical core 206 is about 10 μm to about 40 μm, and the second cladding layer 208 extends radially beyond about 40 μm.

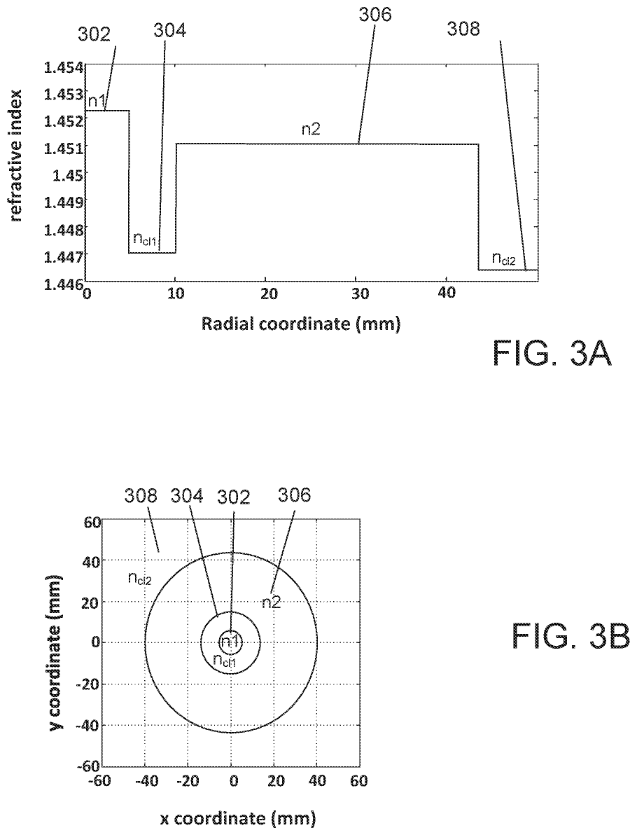

The refractive index profile of yet another exemplary embodiment of a concentric MCF fiber having two concentric cores is described with reference to FIGS. 3A and 3B. FIG. 3A shows the refractive index profile as a function of radial position from the center of the fiber, while FIG. 3B shows the refractive index contours of a cross-sectional profile of the fiber. In this embodiment, there is a central core 302 of material having a first relatively high refractive index, n1. The central core 302 is surrounded by a first cladding layer 304, having a first relatively low refractive index, n_{cl1}. The first cladding layer 304 is surrounded by a first cylindrical core 306 having a relatively high refractive index, n2 that is different from the first high refractive index, n1. In the illustrated embodiment, n2 is less than n1, although this is not a necessary condition, and in other embodiments, n2 may be greater than n1. The first cylindrical core 306 is surrounded by a second cladding layer 308, having a second relatively low refractive index of n_{cl2}. In the illustrated embodiment, n_{cl2} is less than n_{cl1}, although this is not a necessary condition, and in other embodiments, n_{cl2} may be greater than n_{cl1}. The radial extents of the concentric core regions 302, 306 are similar to those shown in FIGS. 2A and 2B, although they may also have different values.

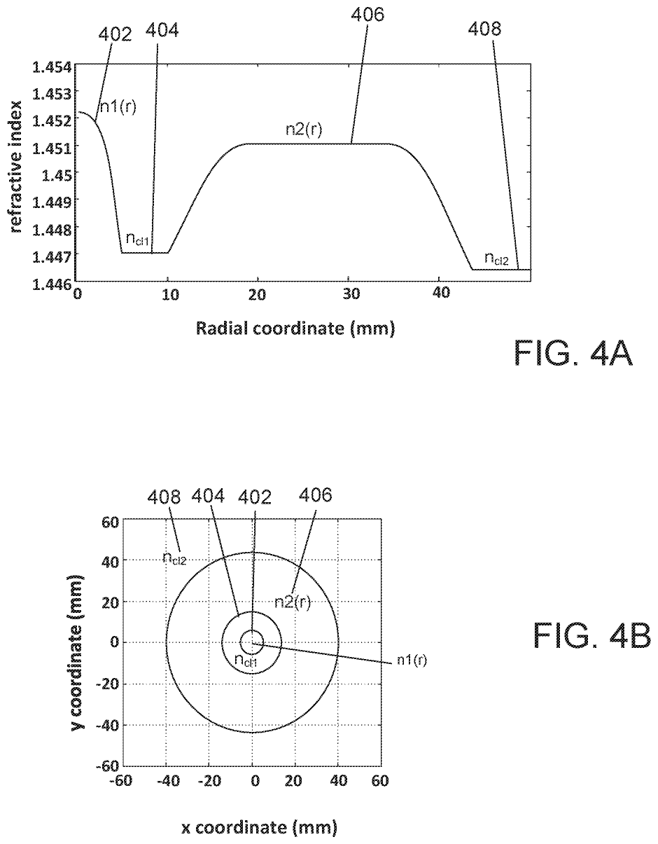

It should be understood that the refractive index profiles of the various regions of the concentric MCF need not be flat, and that the profiles discussed above with reference to FIGS. 1-3 are merely exemplary. On other embodiments, the refractive index profiles may be graded. Further, it is understood that the transition in refractive index between a core and a cladding layer is not a step function in practice, but may extend radially over a micron or more. One embodiment of a concentric MCF with graded index profiles is now described with reference to FIGS. 4A and 4B. FIG. 4A shows the refractive index profile as a function of radial position from the center of the fiber, while FIG. 4B shows the refractive index contours of a cross-sectional profile of the fiber. In this embodiment, the central core 402 is formed of material having a first relatively high refractive index, n1(r), which varies radially with radial position. The central core 402 is surrounded by a first cladding layer 404, having a first relatively low refractive index, n_{cl1}. The first cladding layer 404 is surrounded by a first cylindrical core 406 as having a relatively high refractive index, n2(r) that varies radially. In this embodiment, the maximum value of n2(r) is different from the maximum value of n1(r), although this not need be the case. The first cylindrical core 406 is surrounded by a second cladding layer 408, having a second relatively low refractive index, n_{cl2}. In this embodiment, the first cladding layers 404, 408 have radially uniform refractive indices n_{cl1} and n_{cl1} respectively, but these may vary radially also.

The present invention is not limited to those embodiments of MCF described above. For example, the concentric MCF may have a central, single mode core for a first wavelength range and a concentric multimode core for another wavelength range. In illustration, a central, single mode core may carry an optical signal in the wavelength range 1285-1650 nm, whereas the concentric multimode core carries an optical signal in the range 400-700 nm or, for example, 800-1600 nm. In another example, there may be more than one concentric cylindrical core surrounding the central core, with different concentric cores positioned at increasing radial distances from the central core. Concentric MCFs are further described in U.S. patent application Ser. No. 15/996,018, filed on Jun. 1, 2018, and incorporated herein by reference.

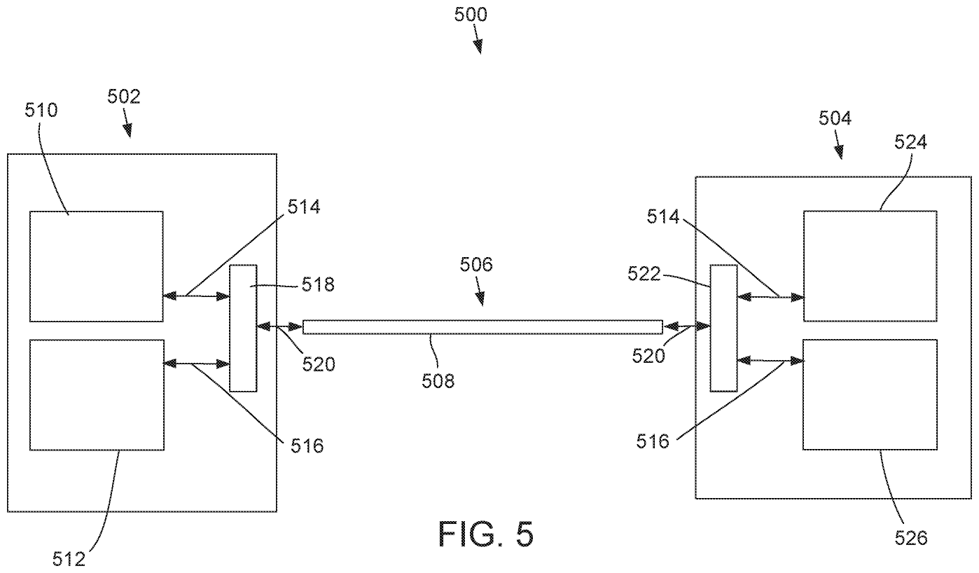

An exemplary embodiment of an optical communication system 500 that uses a concentric MCF according to the present invention is schematically illustrated in FIG. 5. The optical communication system 500 generally has a transmitter portion 502, a receiver portion 504, and a fiber optic portion 506. The fiber optic portion 506 is coupled between the transmitter portion 502 and the receiver portion 504 for transmitting optical signals from the transmitter portion 502 to the receiver portion 504. The fiber optic portion 506 may include one or more lengths of optical fiber arranged in series between the transmitter portion 502 and the receiver portion 504, and is not restricted to only a series of single fibers, but may also include more than one fiber in parallel.

In this embodiment, the optical communication system 500 is of a space division multiplexing (SDM) design. Optical signals are generated within the transmitter portion 502 and are combined into cores of a concentric multicore fiber (MCF) 508 in the optical fiber portion 506 and transmitted to the receiver portion 504, where the signals that propagated along different fiber cores are spatially separated and directed to respective optical units, such as wavelength demultiplexers, detectors, add/drop filters, and the like. The illustrated embodiment shows an optical communication system 500 that spatially multiplexes two different signals, although it will be appreciated that optical communications systems may spatially multiplex different number of signals, e.g. two, three or more than four. Additionally, the fiber optical portion 506 is shown as having a single concentric MCF 508, but it may have more than one concentric MCF 508.

The transmitter portion 502 includes two transmitter units 510, 512 producing respective optical signals 514, 516. The optical communication system 500 may operate at any useful wavelength, for example in the range 800-1000 nm, or over other wavelength ranges, such as 1250 nm-1350 nm, 1500 nm-1600 nm, or 1600 nm-1650 nm. Each transmitter unit 510, 512 is coupled to the optical fiber system 506 via an SDM coupler 518, that directs the optical signals 516, 518 into respective cores of the concentric MCF 508. Embodiments of the SDM coupler 518 are discussed below.

The multi-spatial mode optical signal 520 from the SDM coupler propagates into and along the optical fiber system 506 to the receiver portion 504, where it is split by a second SDM coupler 522 into the optical signals 514, 516 corresponding to the different cores of the concentric MCF 508 that were excited by light from the SDM coupler 518. Thus, according to this embodiment, the transmitter unit 510 produces an optical signal 514, which is transmitted via a first core of the concentric MCF 508 to the receiver unit 524, and the transmitter unit 512 produces an optical signal 516 which is transmitted via a second core of the concentric MCF 508 to the receiver unit 526.

Furthermore, in many optical communications systems there are optical signals propagating in both directions along an optical fiber. This possibility is indicated in FIG. 5, where the optical signals are designated with double-headed arrows. In such a case, the transmitter units and receiver units may be replaced by transceiver units that generate and receive signals that propagate along a particular mode of the concentric MCF 508. In other embodiments, there may be a separate transmitter unit and receiver unit for a signal at each end of the optical fiber system 506.

In addition, a signal from a transmitter need not be restricted to only one wavelength. For example, one or more of the transmitter units 510, 512 may produce respective wavelength division multiplexed signals 514, 516 that propagate along their respective cores of the concentric MCF 508. In such a case, the receiver units 524, 526 may each be equipped with wavelength division demultiplexing capabilities so that the optical signal at one specific wavelength can be detected independently from the optical signals at other wavelengths.

In this particular embodiment, the fiber optical portion 506 comprises a first channel for carrying broadband data, for example cable television or internet traffic, and a second channel for carrying system management information that does not require the same bandwidth as the broadband data, for example telemetry data, data that assists in monitoring the network, traffic load information (useful for balancing traffic in different branches of a network) an optical time domain reflectometry signal, fault indication and the like. Some of these applications, for example fault indication, may use detectors at each end of the fiber portion to monitor whether there is a change in power. Such precautions may be advantageous in determining whether there is a fault or intrusion to the fiber portion when transmitting sensitive data.

This embodiment may use, for example, a concentric MCF 508 that has a single mode central core for the broad bandwidth data and a multimode concentric cylindrical core for the narrower bandwidth system management traffic. The maximum capacity of conventional multimode fibers is limited in length, at least in part, by modal dispersion. For example, the length of an OM4 optical fiber carrying a 1 Gb ethernet signal is limited to a few hundred meters. However, in an application such as this where the multimode core is not being used near its bandwidth capacity, it can potentially carry narrowband information over a longer distance, for example a few km.

There is no restriction on the type of SDM coupler used. For example, the SDM coupler may include a photonic lantern, or may include an arrangement of single core fibers that are tapered so their cores are aligned with respective cores of the concentric MCF. In other arrangements, the signals from the transmitter units may be provided via respective single core fibers whose outputs are imaged to the input face of the concentric MCF using focusing elements such as lenses, diffractive optical elements or the like. Another approach, using diffractive optical elements (DOEs), is described in more detail in U.S. Application No. 62/864,774, titled “Multifiber Connector for Concentric-Core Fiber,” with attorney docket no. 02316.7787USP1, filed on even date herewith, and incorporated by reference. That application describes how various arrangements of DOEs may act as multiplexers/demultiplexers (mux/demux) for coupling from single core fibers to concentric MCFs, and as add/drop filters.

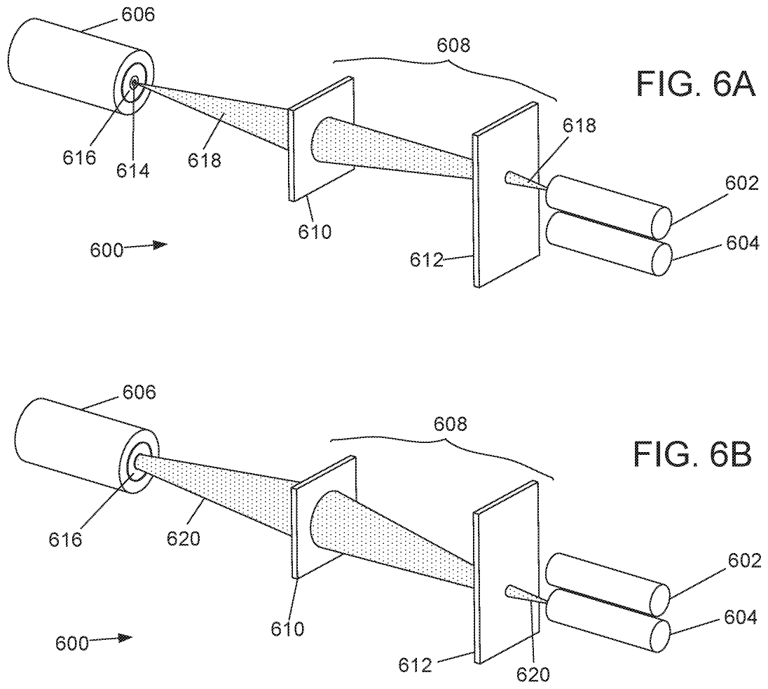

One embodiment of SDM coupler 600 unit that may be used in conjunction with the system 500 is now described with reference to FIGS. 6A and 6B. The SDM coupler unit 600 employs two single core fibers (SCFs) 602, 604. The first SCF 602 is a single mode fiber that carries the broadband data signal. The second SCF 604 is a multimode fiber, for example an OM3 or OM4 fiber that carries the system management signal. On the other side of the SDM coupler unit 600 is the concentric MCF 606. In this case, the concentric MCF 606 has two cores, a central single mode core 614 and a cylindrically concentric multimode core 616. Between the two sets of fibers the SDM coupler 608 includes a first DOE 610 and a second DOE 612.

FIG. 6A schematically illustrates a beam 618 coupling between the first SCF 602 and the central single mode core 614 of the concentric MCF 606. For this beam 618, the combination of DOE elements 610 and 612 images the light between the end of the single mode core of the first SCF 602 and the end of the central, single mode core 614 of the concentric MCF. FIG. 6B schematically illustrates a beam 620 coupling between the second SCF 604 and the multimode core 616 of the concentric MCF 606. For this beam 620, the combination of DOE elements 610 and 612 images the light between the end of the multimode core of the second SCF 604 and the end of the cylindrical, multimode core 616 of the concentric MCF 606.

It will be appreciated that light may propagate in either direction through the SDM coupler arrangement 600, either from the two SCFs 602, 604 to the concentric MCF, or vice versa.

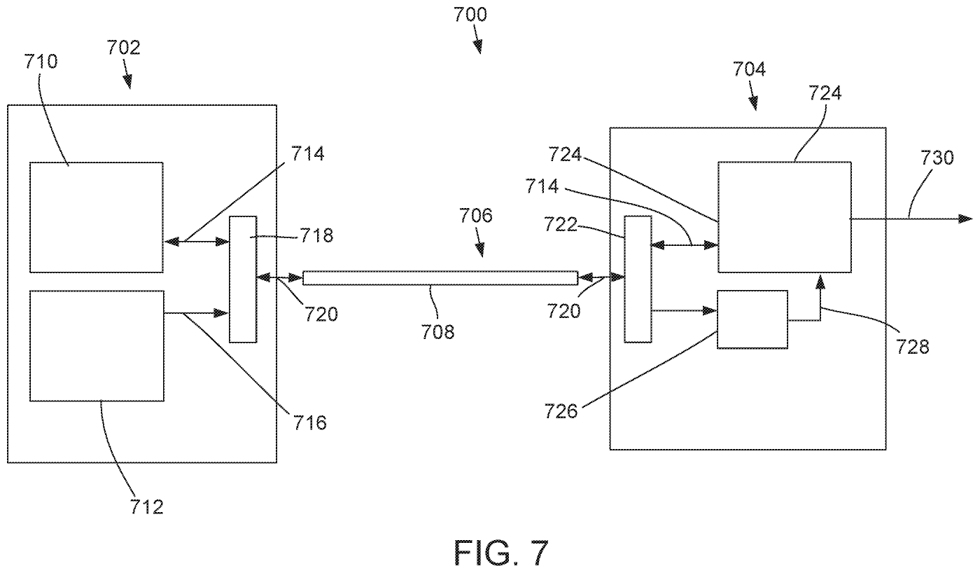

Another type of optical communications system 700 according to the present invention is described with reference to FIG. 7. In this system 700, the concentric MCF fiber includes a central single mode core for carrying data, such as cable television or internet data, while the surrounding multimode core is used to transfer optical power that can be converted remotely to an electrical signal that can power equipment at the far end of the fiber, e.g. like power over Ethernet.

The optical communication system 700 generally has a transmitter portion 702, a receiver portion 704, and a fiber optic portion 706. The fiber optic portion 706 is coupled between the transmitter portion 702 and the receiver portion 704 for transmitting optical signals from the transmitter portion 702 to the receiver portion 704. The fiber optic portion 706 may include one or more lengths of optical fiber arranged in series between the transmitter portion 702 and the receiver portion 704, and is not restricted to only a series of single fibers, but may also include more than one fiber in parallel.

Optical signals are generated within the transmitter portion 702 and are combined into cores of a concentric multicore fiber (MCF) 708 in the optical fiber portion 706 and transmitted to the receiver portion 704, where the signals that propagated along different cores are spatially separated. In this embodiment the concentric MCF 708 includes a single mode, central core surrounded by a cylindrical, multi-radial mode core, although it will be appreciated that the system 700 may spatially multiplex different number of signals, e.g. two, three or more than four. For example, the concentric MCF may include a first central, single mode core surrounded by a first cylindrical, single radial mode core, which is surrounded by a second cylindrical core that is multi-radial mode.

The transmitter portion 702 includes two transmitter units 710, 712 producing respective optical signals 714, 716. Each transmitter unit 710, 712 is coupled to the optical fiber system 706 via an SDM coupler 718, that directs the optical signals 716, 718 into respective cores of the concentric MCF 708. Embodiments of the SDM coupler 718 have been discussed above.

The multi-spatial mode optical signal 720 from the SDM coupler 718 propagates into and along the optical fiber system 706 to the receiver portion 704, where it is split by a second SDM coupler 722 into the optical signals 714, 716 corresponding to the different cores of the concentric MCF 708 that were excited by light from the SDM coupler 718. Thus, according to this embodiment, the transmitter unit 710 produces an optical signal 714, for example an optical data signal for cable television, internet traffic and the like, which is transmitted via a first core of the concentric MCF 708 to the processing unit 724. The second transmitter unit 712 produces an optical power signal 716 which is transmitted via a second core of the concentric MCF 708, which supports multiple radial modes, to the optical/electrical conversion unit 726.

In this embodiment, the optical/electrical conversion unit 726 receives the optical power that is transmitted as optical signal 716, and converts it to electrical power that is coupled via an electrical connection 728 to the processing unit 724. The conversion of optical power to electrical power may take place using a photodetector, for example a photodiode or photovoltaic cell. The processing unit 724 uses the electrical power received over electrical connection 728 to enable its function. The processing unit 724 may, for example, include a receiver that converts the optical signal 714 into electrical signals for subsequent transmission to other devices. In other embodiments, the processing unit 724 may include a photonic circuit for management of the optical signal 716, such as a programmable add/drop filter or the like. One or more outputs 730 from the processing unit 724 may be directed to additional devices downstream of the receiver portion 704, for example subsequent add/drop filters, end users, etc.

In other embodiments, electrical power from optical/electrical conversion unit 726 may be directed to other units of the receiver portion 704 that do not necessarily operate directly on the optical data signal 714, for example temperature management equipment, telemetry equipment, CCD cameras, burglar alarms, WiFi routers, and the like.

The optical communication system 700 may operate at any useful wavelength, for example in the range 800-950 nm, or over other wavelength ranges, such as 1250 nm-1350 nm, 1500 nm-1600 nm, or 1600 nm-1650 nm. For example, the data signal 714 may be produced at a wavelength of around 1310 nm or 1550 nm. It will be appreciated that the data signal 714 may be a WDM signal that includes a number of components each at its own unique wavelength. The power signal 716 may be produced at any suitable wavelength that can propagate efficiently along the length of the fiber portion 706. For example, for relatively short fiber portions 706, around a few 100 m, wavelengths over the ranges 800-950 nm, 1250 nm-1350 nm, 1500 nm-1600 nm, or 1600 nm-1650 nm may be used. For longer fiber portions, e.g. over one km, it may be preferred to use a wavelength in the range 1250-1350 nm or 1500-1600 nm for which attenuation in silica fibers is low. For example, in some embodiments, the transmitter unit 712 may generate the optical power signal 716 using an erbium-doped fiber laser, a type of laser that can readily produce a continuous output having a power in the range of a few tens of Watts, and whose output is readily compatible with launching into the fiber portion 706.

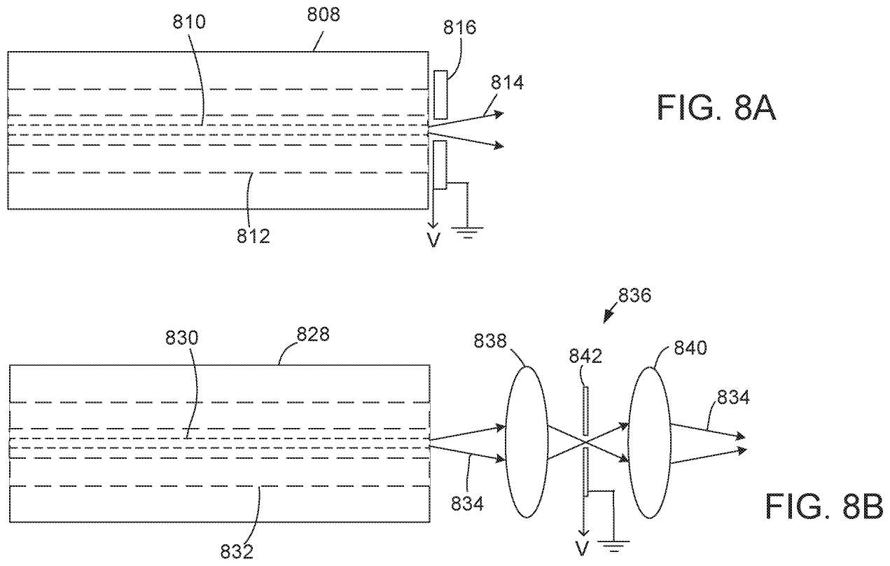

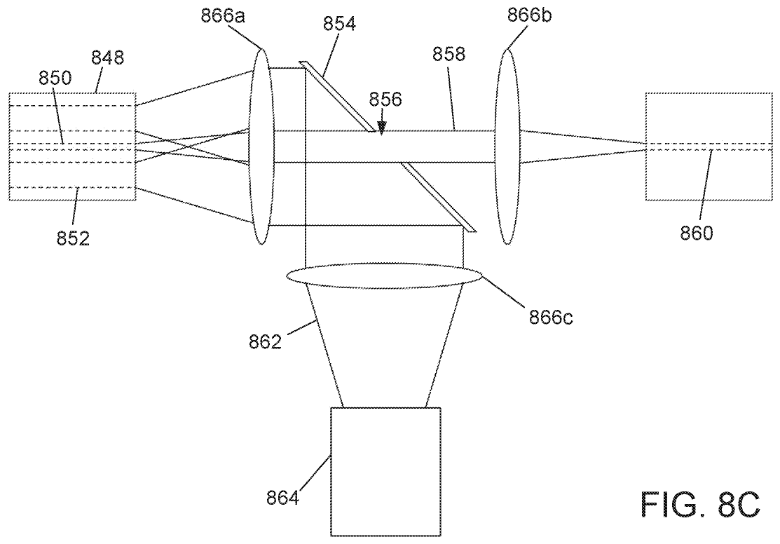

In the illustrated embodiment, the data signal 714 and the optical power signal 716 are separated in an SDM coupler 722 before the power signal 716 is converted to an electrical signal. Other approaches to converting the optical power signal 716 to the electrical power signal may also be used. For example, a photodetector may be placed at the output of the fiber portion 706 that intercepts the power signal 716 while transmitting the data signal 714. One embodiment for using such an approach is described with reference to FIG. 8A. The concentric MCF 808 has a central, single mode core 810 surrounded by a cylindrically concentric multi-radial mode core 812. The central, single mode core 810 carries the broadband data signal while the multi-radial mode core 812 carries the optical power signal. A photodetector 816, such as a photodiode, is positioned at the output end of the concentric MCF 808. The photodetector 816 has an aperture and may be annular in shape. The aperture of the annular photodetector 816 is placed in front of the central, single mode core 810, so that the data signal 814 is transmitted. The data signal 814 can then be processed in the desired fashion, for example directed to a photonic circuit, directed to a wavelength demultiplexer, retransmitted along another fiber, or the like. The electrical signal produced by the photodetector 816 can be used for its desired purpose.

Another embodiment for using such an approach is described with reference to FIG. 8B. A concentric MCF 828 has a central, single mode core 830 surrounded by a cylindrically concentric multi-radial mode core 832. The light output from the end of the concentric MCF is directed to a spatial filter 836, which includes two focusing elements 838, 840, separated by a photodetector 842 that has an aperture. The photodetector 842 may be annular. The data signal 834 from the central, single mode core 830 diverges from the end of the fiber 828 towards the spatial filter 836. The first focusing element 838 is positioned at a distance from the fiber 828 such that the data signal 834 is brought to a focus at the aperture of the photodetector 842. The data signal 834, therefore, passes through the photodetector 842 to the second focusing element 840 which changes the divergence of the data signal 834, for example by collimating it or refocusing it. The data signal 834 can then be processed in any desired fashion, for example directed to a photonic circuit, directed to a wavelength demultiplexer, retransmitted along another fiber, or the like. The optical power signal that exits the fiber 828 from the cylindrically concentric multi-radial mode core 832 is not imaged to the aperture of the photodetector 842 but, instead, is intercepted by the photodetector 842, which generates a resulting electrical signal that can be used for the desired purpose.

Another embodiment is described with reference to FIG. 8C. A concentric MCF 848 has a central, single mode core 850 surrounded by a cylindrically concentric multi-radial mode core 852. The light output from the end of the concentric MCF 848 propagates to a mirror 854 having an aperture 856. Light 858 from the central, single mode core 850 passes through the aperture 856 to a single mode waveguide 860 which may be, for example, in a fiber or a waveguide on an optical chip. The light 862 from the multi-mode core 852 reflects from the mirror 854 towards the photodetector 864 which converts the optical energy to electrical energy that can be used as desired. Focusing elements 866a, 866b, 866c, such as lenses, of appropriate focal length may be used to condition the light beams 858, 862 as they propagate between the concentric MCF 848 and their respective destinations. In the illustrated embodiment, the concentric MCF 848 is positioned from the first focusing element 866a at a distance which results in the light beam 858 being substantially collimated as it propagates between the focusing elements 866a and 866b. This need not be the case, and the light beam 858 may be diverging or converging between the focusing elements lenses 866a and 866b, or may come to a focus, in a manner similar to the embodiment illustrated in FIG. 8B.

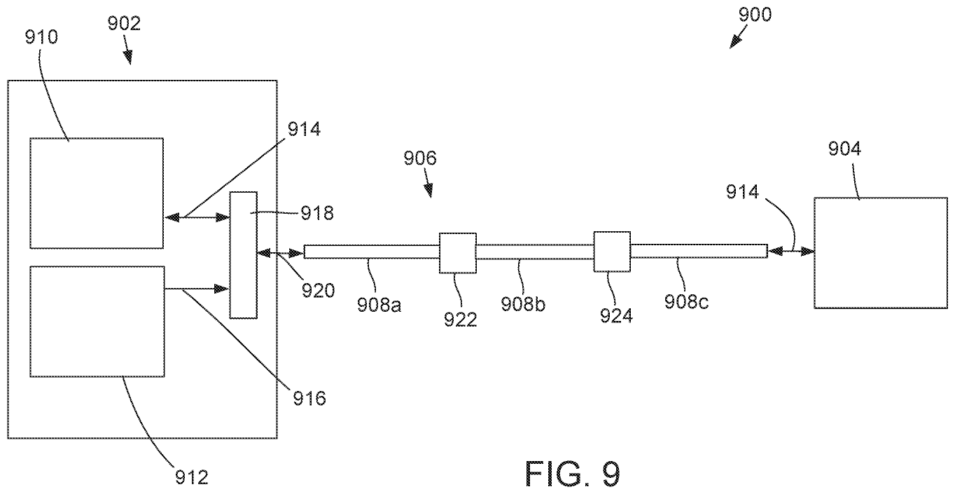

Another type of fiber system 900 according to the present invention is described with reference to FIG. 9. In this system 900, the concentric MCF fiber includes a central single mode core for carrying a broadband data signal, such as cable television or internet data, while the surrounding multimode core is used to transmit optical power that is used for pumping a remote fiber amplifier located along the fiber portion to increase the strength of the data signal.

The optical communication system 900 generally has a transmitter portion 902, a receiver portion 904, and a fiber optic portion 906. The fiber optic system 906 is coupled between the transmitter portion 902 and the receiver portion 904 for transmitting optical data signals from the transmitter portion 902 to the receiver portion 904. The fiber optic system 906 may include one or more lengths of optical fiber arranged in series between the transmitter portion 902 and the receiver portion 904, and is not restricted to only a series of single fibers, but may also include more than one fiber in parallel.

Optical signals are generated within the transmitter portion 902 and are combined into cores of a concentric multicore fiber (MCF) 908 in the optical fiber system 906. The data signals 914 are transmitted to the receiver portion 904. In this embodiment the concentric MCF 908a includes a single mode, central core surrounded by a cylindrical, multi-radial mode core, although it will be appreciated that the system 900 may spatially multiplex a different number of signals, e.g. two, three or more than four. For example, the concentric MCF 908a may include a first central, single mode core surrounded by a first cylindrical, single radial mode core, which is surrounded by a second cylindrical core that is multi-radial mode.

The transmitter portion 902 includes two transmitter units 910, 912 producing respective optical signals 914, 916. The first transmitter unit 910 produces an optical data signal 914 that is to be transmitted to the receiver portion 904. The second transmitter unit 912 generates pump light for pumping a fiber amplifier in the fiber portion 906. Each transmitter unit 910, 912 is coupled to the optical fiber system 906 via an SDM coupler 918, that directs the optical signals 916, 918 into respective cores of the concentric MCF 908a. Embodiments of the SDM coupler 918 have been discussed above.

The optical fiber portion 906 includes a first concentric MCF 908a that transmits both the data signal 914 and the pump signal 916 in a direction towards the receiver portion. The optical fiber portion also includes a fiber amplifier 908b, which typically includes a single mode core that is doped with a metallic species that can, when excited to a selected energy level, amplify the optical signal passing therealong. One common type of fiber amplifier is an erbium-doped fiber amplifier (EDFA), which can amplify signals at around 1525-1565 nm and around 1570-1610 nm. Thus, an EDFA can be used for amplifying signals at the wavelength of around 1550 nm where attenuation in silica fibers is close to a minimum. The second transmitter unit 912 produces light at a wavelength appropriate to pump the fiber amplifier 908b. In the case of an EDFA, the erbium ions doped in the fiber can be pumped with light at around 980 nm and around 1480 nm, and so the second transmitter unit 912 preferably produces pump light at either, or both, of these wavelengths.

A coupler 922 can be used to couple the concentric MCF 908a with the fiber amplifier 908b. The coupler 922 may simply use a butt-coupling between the fibers 908a, 908b, with the central, single mode cores aligned. The pump light in the concentric MCF 908 will propagate along the cladding of the fiber amplifier, and will intersect with the doped core. In another embodiment, the coupler 922 may be a wavelength selective coupler that can combine the data signal light and the pump light into the fiber amplifier 908b. The fiber amplifier 908b may include an isolator at its end to prevent reflections from downstream components returning through the amplifier and compromising its operation.

A final section of single mode fiber 908c may be used to complete the fiber path from the fiber amplifier 908b to the receiver portion 904. The single mode fiber 908c may be coupled to the fiber amplifier 908b using a conventional single mode fiber coupler 924.

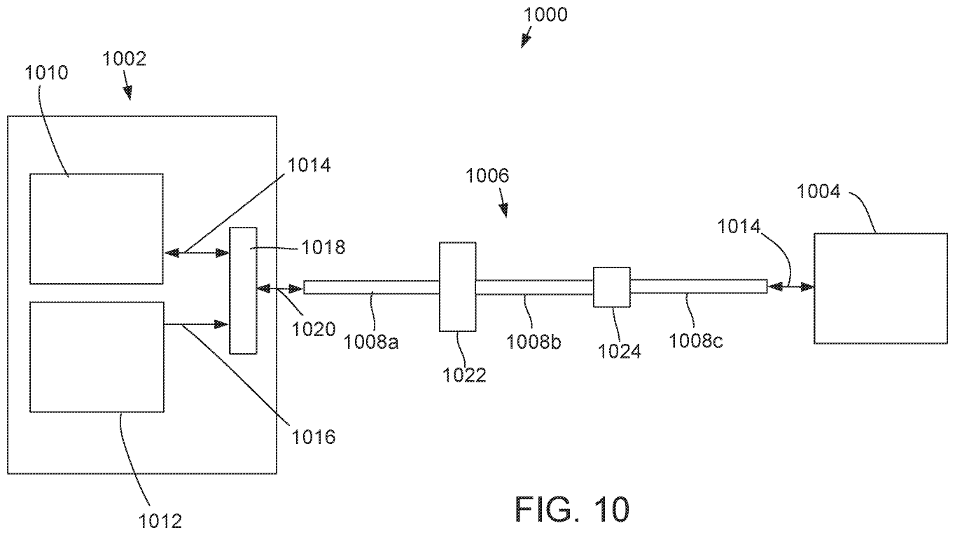

Another type of fiber system 1000 according to the present invention is described with reference to FIG. 10. This system 1000 also includes a fiber amplifier and may be advantageous to use in situations when it is desired to position the fiber amplifier at a further distance than is feasible for the system 900. Some amplifier systems, such as the EDFA, are most effectively pumped by light whose wavelength does not necessarily correspond to attenuation minima of the silica fiber. As a result, the reach of the pump light from the transmitter portion may be limited. In the fiber system 1000, optical power is transmitted along the fiber at a wavelength that has low attenuation. At the desired point along the fiber system, the optical power is converted to electrical power that is then used to provide energy to a remote pump laser for the fiber amplifier. In this system 1000, a first concentric MCF fiber includes a central single mode core for carrying data, such as cable television or internet data, while the surrounding multimode core is used to transmit optical power that is used for remotely powering a fiber amplifier pump.

The optical communication system 1000 generally has a transmitter portion 1002, a receiver portion 1004, and a fiber optic portion 1006. The fiber optic system 1006 is coupled between the transmitter portion 1002 and the receiver portion 1004 for transmitting optical data signals from the transmitter portion 1002 to the receiver portion 1004. The fiber optic system 1006 may include one or more lengths of optical fiber arranged in series between the transmitter portion 1002 and the receiver portion 1004, and is not restricted to only a series of single fibers, but may also include more than one fiber in parallel.

Optical signals are generated within the transmitter portion 1002 and are combined into cores of a concentric MCF 1008a in the optical fiber system 1006. The data signal 1014 is transmitted to the receiver portion 1004. In this embodiment the concentric MCF 1008a includes a single mode, central core surrounded by a cylindrical, multi-radial mode core, although it will be appreciated that the system 1000 may spatially multiplex a different number of signals, e.g. two, three or more than four. For example, the concentric MCF 1008a may include a first central, single mode core surrounded by a first cylindrical, single radial mode core, which is surrounded by a second cylindrical core that is multi-radial mode.

The transmitter portion 1002 includes two transmitter units 1010, 1012 producing respective optical signals 1014, 1016. The first transmitter unit 1010 produces an optical data signal 1014 that is to be transmitted to the receiver portion 1004, for example cable television or internet signals. The second transmitter unit 1012 produces an optical signal 1016 that is transmitted via a second core of the concentric MCF 1008, which supports multiple radial modes, to the amplifier pump unit 1022.

In this embodiment, the amplifier pump unit 1022 receives the optical power that is transmitted as optical signal 1016, and converts it to electrical power, in a manner as described above, that drives a pump laser for the fiber amplifier 1008b, for example one or more semiconductor diode lasers. Thus, the amplifier pump unit 1022 receives power remotely from, and is controlled by, the transmitter portion 1002. The amplifier pump unit 1022 also couples the data signal 1014 from the concentric MCF 1008a to the core of the fiber amplifier 1008b.

A final section of single mode fiber 1008c completes the fiber path from the fiber amplifier 1008b to the receiver portion 1004. The single mode fiber 1008c may be coupled to the fiber amplifier 1008b using a conventional single mode fiber coupler 1024.

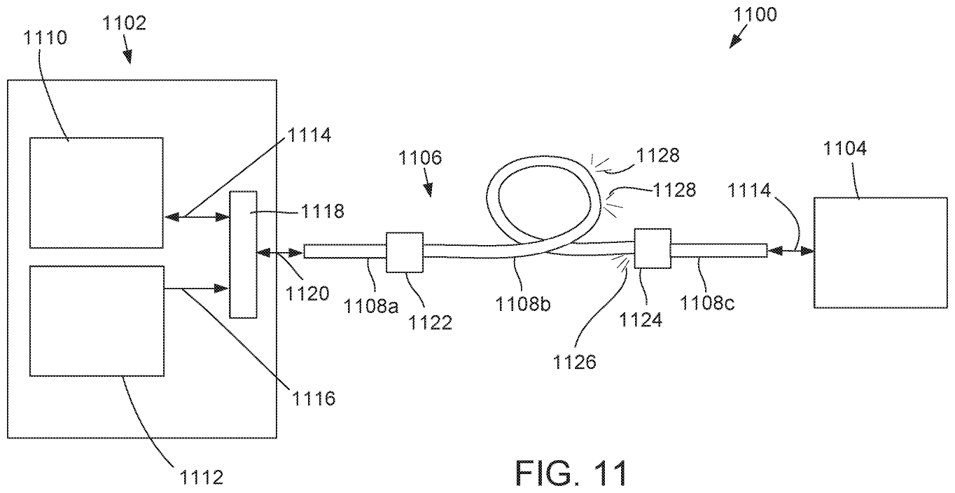

Another embodiment of an optical communications system 1100 that may use a concentric MCF is schematically illustrated in FIG. 11. In this embodiment the system 1100 employs a concentric MCF to carry a data signal and a fault-finding signal. The system 1100 generally has a transmitter portion 1102, a receiver portion 1104, and a fiber optic portion 1106. The fiber optic portion 1106 is coupled between the transmitter portion 1102 and the receiver portion 1104 for transmitting optical data signals from the transmitter portion 1102 to the receiver portion 1104. The fiber optic portion 1106 may include one or more lengths of optical fiber arranged in series between the transmitter portion 1102 and the receiver portion 1104, and is not restricted to only a series of single fibers, but may also include more than one fiber in parallel.

Optical signals are generated within the transmitter portion 1102 and are combined into cores of a concentric MCF 1108 in the optical fiber portion 1106 and transmitted to the receiver portion 1104, where the optical data signal is received for detection, processing, or some other function. In this embodiment the concentric MCF 1108a includes a single mode, central core surrounded by a cylindrical, multi-radial mode core, although it will be appreciated that the system 1100 may spatially multiplex different number of signals, e.g. two, three or more than four. For example, the concentric MCF 1108a may include a first central, single mode core surrounded by a first cylindrical, single radial mode core, which is surrounded by a second cylindrical core that is multi-radial mode. In the illustrated embodiment, the fiber portion 1106 includes three concentric MCFs 1108a, 1108b, 1108c connected in series by couplers 1122, 1124. However, the fiber portion 1106 may have a greater or smaller number of concentric MCFs. Furthermore, the central core may be multimode while the outer, cylindrical core is single mode.

The transmitter portion 1102 includes a first transmitter unit 1110 which transmits an optical data signal 1114 to the SDM coupler 1118 for coupling into a core, preferably a central, single mode core of the concentric MCF 1108a. The optical data signal 1114 may carry, for example, cable television or internet data. The second transmitter unit 1112 transmits a connectivity-indicating signal 1116, which may be, for example a light signal that is visible to the human eye. The human eye is frequently understood to be able to detect light in the range 400 nm-700 nm, although this range is approximate, and it may be possible to detect light outside this range with the eye. When this range is used, it should be understood to mean that range of wavelengths that are detectable by the human eye. The connectivity-indicating signal 1116 is coupled into a core of the concentric MCF 1108a, for example a concentric multimode core of the concentric MCF 1108a. The connectivity-indicating signal 1116 may be used for monitoring the system, for example to monitor the quality of connections at connectors. An incomplete connection at connector 1124 may be indicated, for example, by some of the connectivity-indicating signal 1116 escaping as a visible fault signal 1126 at the connector 1124. In the case where the connectivity-indicating signal 1116 comprises visible light, a technician examining the connector 1124 may readily trace a faulty or incomplete connection by seeing the fault signal 1126. The connectivity indicating signal 1116 may also be used to produce a fault signal 1128 escaping from the side of a concentric MCF 1108b that has a bend of a sufficiently small radius of curvature. This may be used to indicate when a fiber is bent so tightly that it is in danger of leaking some of the optical data signal 1114. Furthermore, the system may use detectors at each end of the fiber portion to monitor whether there is a change in power propagating along the multimode core. Such precautions may be advantageous in determining whether there is a fault or intrusion to the fiber portion when transmitting sensitive data.

Various modifications, equivalent processes, as well as numerous structures to which the present invention may be applicable will be readily apparent to those of skill in the art to which the present invention is directed upon review of the present specification. For example, although many of the examples provided herein were discussed with the concentric MCFs having two concentric cores, one single mode core and a multimode core, the invention is intended to cover systems that use concentric MCFs having different numbers of concentric cores.

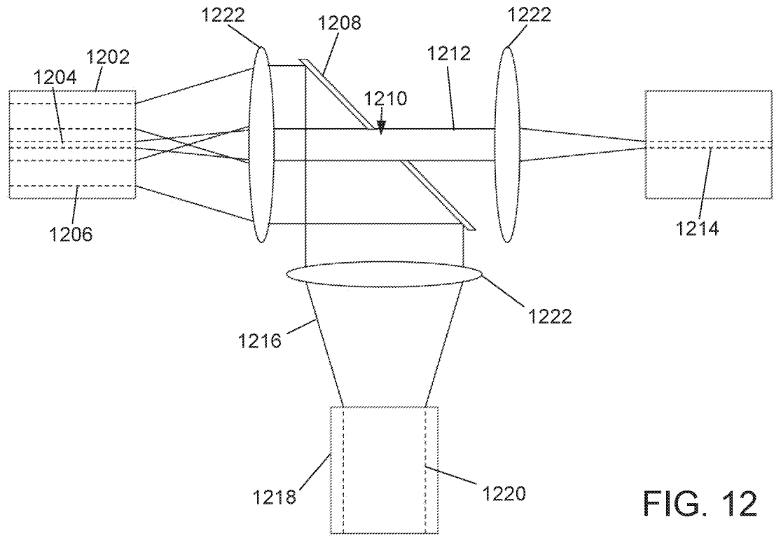

Another embodiment of SDM coupler for coupling light between a concentric MCF and respective single mode and multimode fibers is schematically illustrated in FIG. 12. A concentric MCF 1202 has a central, single mode core 1204 surrounded by a cylindrically concentric multi-radial mode core 1206. The light output from the end of the concentric MCF 1202 propagates to a mirror 1208 having an aperture 1210. The light 1212 from the central, single mode core 1204 passes through the aperture 1210 to a single mode waveguide 1214 which may be, for example, in a fiber or a waveguide on an optical chip. The light 1216 from the multi-mode core 1206 reflects from the mirror 1208 towards a multimode fiber 1218. The multimode fiber 1218 may have a conventional multimode core 1220, or may have a concentric, hollow cylinder multimode core in the manner of concentric MCFs.

Focusing elements 1222, such as lenses, of appropriate focal length may be used to condition the light beams 1212, 1216 as they propagate between the concentric MCF 1202 and the single mode waveguide 1214 and the multimode fiber 1218. The light beams 1212, 1216 may be diverging, be converging, or come to a focus, between focusing elements 1222.

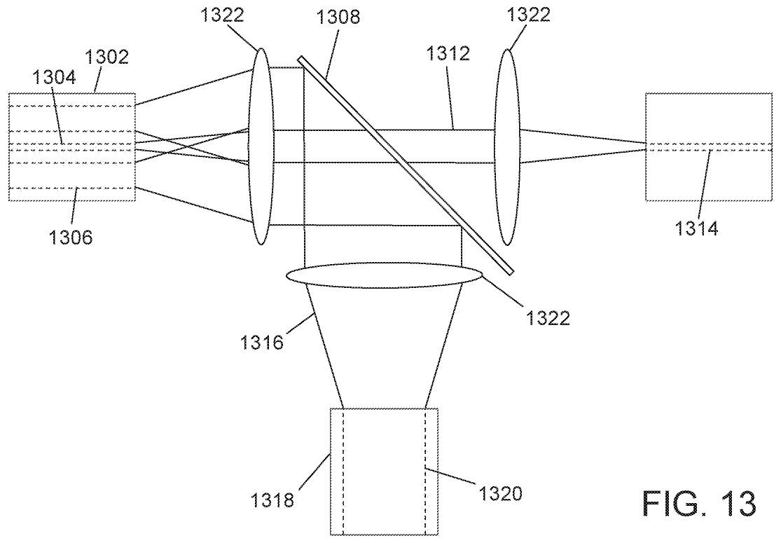

Another embodiment of SDM coupler for coupling light between a concentric MCF and respective single mode and multimode fibers is schematically illustrated in FIG. 13, where the light in the single mode fiber is at a different wavelength from the light in the multimode fiber. A concentric MCF 1302 has a central, single mode core 1304 surrounded by a cylindrically concentric multi-radial mode core 1306. The light output from the end of the concentric MCF 1302 propagates to a wavelength-sensitive reflecting element 1308. The light 1312 from the central, single mode core 1304 is transmitted through the wavelength-sensitive reflecting element 1308 to a single mode waveguide 1314 which may be, for example, in a fiber or a waveguide on an optical chip. The light 1316 from the multimode core 1306 reflects from the wavelength-sensitive reflecting element 1308 towards a multimode fiber 1318. The multimode fiber 1318 may have a conventional multimode core 1320, or may have a concentric, hollow cylinder multimode core.

Focusing elements 1322, such as lenses, of appropriate focal length may be used to condition the light beams 1312, 1316 as they propagate between the concentric MCF 1302 and the single mode waveguide 1314 and the multimode fiber 1318. The light beams 1312, 1316 may be diverging, be converging, or come to a focus, between focusing elements 1322. Although the illustrated embodiment shows the multimode light beam 1316 being reflected by the wavelength-sensitive reflecting element 1308 and the single mode light beam 1312 being transmitted through the wavelength-sensitive reflecting element 1308, it should be understood that the configuration could be reversed, i.e. with the multimode light beam 1316 being transmitted through the wavelength-sensitive reflecting element 1308 and the single mode light beam 1312 being reflected by the wavelength-sensitive reflecting element 1308.

The wavelength-sensitive reflecting element 1308 may be any type of mirror that selectively reflects light at one wavelength and transmits light at another wavelength. For example, the wavelength-sensitive reflecting element may comprise a stack of dielectric layers that pass light above a certain wavelength and reflect light below the wavelength, or may reflect light above a certain wavelength and transmit light below the wavelength. This may sometimes be referred to as a dichroic mirror. In other embodiments, the dielectric stack may transmit or reflect light within a certain range of wavelengths (often referred to as a “passband”), while reflecting or transmitting light that lies outside the range. In other embodiments, the wavelength-sensitive reflecting element may be formed of a substrate that transmits light at one wavelength and reflects or absorbs light at another. For example, a silicon substrate may be used to transmit light having a wavelength longer than about 1 μm, while a polished surface on the silicon substrate may be used to reflect light having a wavelength less than about 1 μm. The non-reflecting surface of the wavelength-sensitive reflecting element 1308 may be provided with an anti-reflective coating. Furthermore, the reflecting surface of the wavelength-sensitive reflecting element 1308 may be provided with an antireflective coating to prevent reflection at the wavelength that is desired to be transmitted.

It should be appreciated that the SDM coupler of FIG. 13, that uses a wavelength-sensitive mirror, may be adapted for other purposes. For example, the multimode fiber might be replaced by photodetector which is used to convert the optical power that propagated along the multimode core of the concentric MCF to electrical power.

It will be appreciated that the embodiments shown in FIGS. 12 and 13 may be used to direct light from the concentric MCF to the single mode core and to the multimode fiber, or may be used in the reverse direction to couple light from the single mode core and from the multimode fiber into the concentric MCF. In the case that the multimode fiber contains a conventional multimode core, for example multimode fibers 1218, 1318 contain conventional multimode cores 1220, 1320, the system of lenses may be used to direct a large a portion of the light from the multimode fiber into the cylindrically concentric multimode core, although some of the light may not enter the cylindrically concentric multimode core and may enter the single mode core. However, in many situations the light from the multimode fiber entering the single mode core does not affect the light from the single mode core that propagates along the single mode core of the concentric MCF, for example where the light from the single mode core is at a different wavelength from the light from the multimode fiber. Furthermore, a significant amount of the light from the multimode core that enters the single mode core of the concentric MCF is not confined by the single mode core of the concentric MCF.

Finally, the description of the various concentric MCF-based systems primarily described the optical signals propagating in a single direction, mainly from the transmitter portion to the receiver portion. It should be understood that, for certain embodiments, optical signals may also propagate in the opposite directions, and there is no intention in the present description to limit the direction in which optical signals propagate through the claimed optical devices, unless otherwise stated.

As noted above, the present invention is applicable to fiber optical communication and data transmission systems. Accordingly, the present invention should not be considered limited to the particular examples described above, but rather should be understood to cover all aspects of the invention as fairly set out in the attached claims.

What we claim as the invention is:

1. An optical system, comprising:
a transmitter portion, the transmitter portion comprising at least a first transmitter unit to generate an optical data signal and a second transmitter unit to generate an optical system management signal;
a receiver portion; and
a fiber portion coupling between the transmitter portion and the receiver portion, the fiber portion comprising at least one concentric multicore fiber (MCF), the at least one concentric MCF carrying the optical data signal from the first transmitter unit in a first core and carrying the optical system management signal from the second transmitter unit in a second core.

2. An optical system as recited in claim 1, further comprising a space division multiplexing (SDM) coupler, wherein the optical data signal from the first transmitter unit and the optical system management signal from the second transmitter unit are directed into the concentric MCF via the SDM coupler.

3. An optical system as recited in claim 2, wherein the SDM coupler comprises at least two diffractive optical elements that couple the optical data signal to the concentric MCF from a first single core fiber and the optical system management signal to the concentric MCF from a second single core fiber.

4. An optical system as recited in claim 2, wherein the SDM coupler comprises a reflecting element having an aperture, the optical data signal passing through the aperture and the optical system management signal being reflected by the reflecting element between the second transmitter unit and the at least one concentric MCF.

5. An optical system as recited in claim 2, wherein the SDM coupler comprises a wavelength-sensitive reflecting element, one of the optical data signal and the optical system management signal being transmitted through the wavelength-sensitive reflecting element within the SDM coupler, and the other of the optical data signal and the optical system management signal being reflected by the wavelength-sensitive reflecting element within the SDM coupler.

6. An optical system as recited in claim 1, wherein the receiver portion comprises a first receiver unit coupled to receive the optical data signal from the fiber portion and a second receiver unit coupled to receive the optical system management signal from the fiber portion.

7. An optical system as recited in claim 1, wherein optical system management signal includes information regarding at least one of optical connectivity, received power, data traffic load, wavelengths used, optical time domain reflectometry data and fault information

8. An optical system as recited in claim 1, wherein the first core of the concentric MCF is a single radial mode core and the second core of the concentric MCF is a multi-radial mode core.

9. An optical system, comprising:
a transmitter portion, the transmitter portion comprising at least a first transmitter unit to generate an optical data signal and a second transmitter unit to generate an optical power signal;
a receiver portion; and
a fiber portion coupling between the transmitter portion and the receiver portion, the fiber portion comprising at least one concentric multicore fiber (MCF), the at least one concentric MCF carrying the optical data signal from the first transmitter unit in a first core and carrying the optical power signal in a second core;
wherein the optical power signal is converted to an electrical power signal at the receiver portion, the electrical power signal being used to provide electrical power to one or more components of the receiver portion.

10. An optical system as recited in claim 9, further comprising a space division multiplexing (SDM) coupler, wherein the optical data signal from the first transmitter unit and the optical power signal from the second transmitter unit are directed into the concentric MCF via the SDM coupler.

11. An optical system as recited in claim 10, wherein the SDM coupler comprises at least two diffractive optical elements that couple the optical data signal to the concentric MCF from a first single core fiber and the optical power signal to the concentric MCF from a second single core fiber.

12. An optical system as recited in claim 10, wherein the SDM coupler comprises a reflecting element having an aperture, the optical data signal passing through the aperture and the optical power signal being reflected by the reflecting element between the second transmitter unit and the at least one concentric MCF.

13. An optical system as recited in claim 10, wherein the SDM coupler comprises a wavelength-sensitive reflecting element, one of the optical data signal and the optical power signal being transmitted through the wavelength-sensitive reflecting element within the SDM coupler, and the other of the optical data signal and the optical power signal being reflected by the wavelength-sensitive reflecting element within the SDM coupler.

14. An optical system as recited in claim 9, wherein the receiver portion comprises a first receiver unit coupled to receive the optical data signal from the fiber portion, the first receiver unit being coupled to receive the electrical power signal.

15. An optical system as recited in claim 9, wherein the receiver portion further comprises an SDM coupler to receive a combined optical signal from the fiber portion into the optical data signal and the optical power signal, the optical data signal being directed from the SDM coupler of the receiver portion to a first receiver unit of the receiver portion.

16. An optical system as recited in claim 15, wherein the optical power signal is directed from the SDM coupler of the receiver portion to an optical/electrical converter that converts the optical power signal to the electrical power signal.

17. An optical system as recited in claim 16, wherein the SDM coupler of the receiver portion comprises a reflecting element having an aperture, the optical data signal passing through the aperture and the optical power signal being reflected by the reflecting element to the optical/electrical converter.

18. An optical system as recited in claim 16, wherein the SDM coupler of the receiver portion comprises a wavelength-selective reflecting element, one of the optical data signal and the optical power signal being transmitted through the wavelength-selective reflecting element and the other of optical data signal and the optical power signal being reflected by the reflecting element.

19. An optical system as recited in claim 9, further comprising an optical/electrical converter positioned at an output end of the fiber portion, the an optical/electrical converter having an aperture aligned with the fiber portion so that the optical data signal passes through the aperture, and the optical power signal from the fiber portion is intercepted by the optical/electrical converter.

20. An optical system as recited in claim 9, further comprising an optical/electrical converter having an aperture positioned proximate an output from the fiber portion and a first focusing element disposed between the output of the fiber portion and the optical/electrical converter, such that the optical data signal from the first core of the concentric MCF is focused by the first focusing element through the aperture, and the optical power signal from the second core of the concentric MCF is intersected by the optical/electrical converter.

21. An optical system as recited in claim 9, wherein the first core is a central, single radial mode core of the concentric MCF and the second core is a multi-radial mode cylindrical core of the concentric MCF.

22. An optical system, comprising:
a transmitter portion, the transmitter portion comprising at least a first transmitter unit to generate an optical data signal and a second transmitter unit to generate an optical pump signal;
a receiver portion; and
a fiber portion coupling between the transmitter portion and the receiver portion, the fiber portion comprising at least one concentric multicore fiber (MCF), the at least one concentric MCF carrying the optical data signal from the first transmitter unit in a first core and carrying the optical pump signal in a second core, the fiber coupling portion further comprising a fiber amplifier coupled to receive both the optical data signal and the optical pump signal from the concentric MCF;
wherein the fiber amplifier comprises an amplifying medium, and the optical pump signal has a wavelength selected to be absorbed by the amplifying medium of the fiber amplifier.

23. An optical system as recited in claim 22, further comprising a space division multiplexing (SDM) coupler, wherein the optical data signal from the first transmitter unit and the optical pump signal from the second transmitter unit are directed into the concentric MCF via the SDM coupler.

24. An optical system as recited in claim 23, wherein the SDM coupler comprises a reflecting element having an aperture, the optical data signal passing through the aperture and the optical pump signal being reflected by the reflecting element between the second transmitter unit and the at least one concentric MCF.

25. An optical system as recited in claim 23, wherein the SDM coupler comprises a wavelength-sensitive reflecting element, one of the optical data signal and the optical power signal being transmitted through the wavelength-sensitive reflecting element within the SDM coupler, and the other of the optical data signal and the optical power signal being reflected by the wavelength-sensitive reflecting element within the SDM coupler.

26. An optical system as recited in claim 23, wherein the SDM coupler comprises at least two diffractive optical elements that couple the optical data signal to the concentric MCF from a first single core fiber and the optical pump signal to the concentric MCF from a second single core fiber.

27. An optical system as recited in claim 22, wherein the receiver portion comprises a first receiver unit coupled to receive the optical data signal from the fiber portion.

28. An optical system as recited in claim 22, wherein the fiber portion further comprises a single core fiber coupling the optical data signal from the fiber amplifier to the receiver portion.

29. An optical system as recited in claim 22, wherein the first core is a central, single radial mode core of the concentric MCF and the second core is a multi-radial mode, cylindrical core of the concentric MCF.

30. An optical system, comprising:
a transmitter portion, the transmitter portion comprising at least a first transmitter unit to generate an optical data signal and a second transmitter unit to generate an optical power signal;
a receiver portion; and
a fiber portion coupling between the transmitter portion and the receiver portion, the fiber portion comprising at least one concentric multicore fiber (MCF), the at least one concentric MCF carrying the optical data signal from the first transmitter unit in a first core and carrying the optical power signal in a second core, the fiber portion further comprising a fiber amplifier coupled to receive the optical data signal from the at least one concentric MCF;
wherein the optical power signal is converted to an electrical power signal at an amplifier pump unit of the fiber amplifier, the electrical power signal being used to provide electrical power the amplifier pump unit, whereby the amplifier pump unit provides optical pump power to the fiber amplifier.

31. An optical system as recited in claim 30, further comprising a space division multiplexing (SDM) coupler, wherein the optical data signal from the first transmitter unit and the optical power signal from the second transmitter unit are directed into the concentric MCF via the SDM coupler.

32. An optical system as recited in claim 31, wherein the SDM coupler comprises at least two diffractive optical elements that couple the optical data signal to the concentric MCF from a first single core fiber and the optical power signal to the concentric MCF from a second single core fiber.

33. An optical system as recited in claim 31, wherein the SDM coupler comprises a reflecting element having an aperture, the optical data signal passing through the aperture and the optical power signal being reflected by the reflecting element between the second transmitter unit and the at least one concentric MCF.

34. An optical system as recited in claim 31, wherein the SDM coupler comprises a wavelength-sensitive reflecting element, one of the optical data signal and the optical power signal being transmitted through the wavelength-sensitive reflecting element within the SDM coupler, and the other of the optical data signal and the optical power signal being reflected by the wavelength-sensitive reflecting element within the SDM coupler.

35. An optical system as recited in claim 30, wherein the receiver portion comprises a first receiver unit coupled to receive the optical data signal from the fiber portion.

36. An optical system as recited in claim 30, wherein the fiber portion further comprises a single core fiber coupling the optical data signal from the fiber amplifier to the receiver portion.

37. An optical system as recited in claim 30, wherein the first core is a central, single radial mode core of the concentric MCF and the second core is a multi-radial mode, cylindrical core of the concentric MCF.

38. An optical system as recited in claim 30, wherein the amplifier pump unit comprises a reflecting element having an aperture, the optical data signal passing through the aperture and the optical power signal being reflected by the reflecting element to an optical/electrical converter of the amplifier pump unit.

39. An optical system as recited in claim 30, wherein the amplifier pump unit comprises a wavelength-selective reflecting element, one of the optical data signal and the optical power signal being transmitted through the wavelength-selective reflecting element and the other of optical data signal and the optical power signal being reflected by the reflecting element, the optical power signal being directed to an optical/electrical converter of the amplifier pump unit.

40. An optical system, comprising:
a transmitter portion, the transmitter portion comprising at least a first transmitter unit to generate an optical data signal and a second transmitter unit to generate an optical connectivity-indicating signal, the optical connectivity-indicating signal having a wavelength in the range of approximately 400 nm-700 nm;
a receiver portion; and
a fiber portion coupling between the transmitter portion and the receiver portion, the fiber portion comprising at least one concentric multicore fiber (MCF), the at least one concentric MCF carrying the optical data signal from the first transmitter unit in a first core and carrying the optical connectivity-indicating signal in a second core.

41. An optical system as recited in claim 40, further comprising a space division multiplexing (SDM) coupler, wherein the optical data signal from the first transmitter unit and the optical connectivity signal from the second transmitter unit are directed into the concentric MCF via the SDM coupler.

42. An optical system as recited in claim 41, wherein the SDM coupler comprises at least two diffractive optical elements that couple the optical data signal to the concentric MCF from a first single core fiber and the optical connectivity-indicating signal to the concentric MCF from a second single core fiber.

43. An optical system as recited in claim 41, wherein the SDM coupler comprises a reflecting element having an aperture, the optical data signal passing through the aperture and the optical connectivity-indicating signal being reflected by the reflecting element between the second transmitter unit and the at least one concentric MCF.

44. An optical system as recited in claim 41, wherein the SDM coupler comprises a wavelength-sensitive reflecting element, one of the optical data signal and the optical connectivity-indicating signal being transmitted through the wavelength-sensitive reflecting element within the SDM coupler, and the other of the optical data signal and the optical connectivity-indicating being reflected by the wavelength-sensitive reflecting element within the SDM coupler.

45. An optical system as recited in claim 40, wherein the first core is a central, single radial mode core of the concentric MCF and the second core is a multi-radial mode, cylindrical core of the concentric MCF.
